(19) United States
(12) Patent Application Publication
(10) Pub. No.: US 2016/0007587 A1
(43) Pub. Date: Jan. 14, 2016

(54) Configurable Portable Laser Alarm System

(71) Applicant: David G. Magee, Columbia, MS (US)

(72) Inventor: David G. Magee, Columbia, MS (US)

(21) Appl. No.: 14/327,998

(22) Filed: Jul. 10, 2014

(51) Int. Cl. A01M 31/00; G08B 13/183

(52) U.S. Cl. CPC A01M 31/002; G08B 13/183

(57) ABSTRACT

A configurable portable laser alarm system for use while hunting establishes a user defined area protected by an alarm triggered by interruption of a laser beam. The system includes a plurality of base units and a remote unit. A respective laser is coupled to each base unit to emit a beam outwardly from the base unit. A respective detector is coupled to each base unit to detect the laser beam emitted from another of the base units. A base processor, base transceiver and base actuator are incorporated into each base unit. A remote transceiver is coupled to the remote unit to receive an alarm signal from the base transceiver of each base unit. An alarm is coupled to the remote unit and operationally coupled to a remote processor wherein the alarm selectively generates an alarm sequence or signal when the remote transceiver receives the alarm signal from at least one of the base transceivers.

### BACKGROUND OF THE DISCLOSURE

### Field of the Disclosure

The disclosure relates to alarm devices and more particularly pertains to a new alarm device which may be used while hunting for establishing a user defined area protected by an alarm triggered by interruption of a laser beam.

### SUMMARY OF THE DISCLOSURE

An embodiment of the disclosure meets the needs presented above by generally comprising a plurality of base units and a remote unit. A respective laser is coupled to each base unit to emit a beam outwardly from the base unit. A respective detector is coupled to each base unit to detect the laser beam emitted from another of the base units. A base processor, base transceiver and base actuator are incorporated into each base unit. A remote transceiver is coupled to the remote unit to receive an alarm signal from the base transceiver of each base unit. An alarm is coupled to the remote unit and operationally coupled to a remote processor wherein the alarm selectively generates an alarm sequence or signal when the remote transceiver receives the alarm signal from at least one of the base transceivers.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a configurable portable laser alarm system according to an embodiment of the disclosure.

FIG. 2 is a back view of an embodiment of the disclosure.

FIG. 3 is a front view of an embodiment of the disclosure.

FIG. 4 is a schematic view of an embodiment of the disclosure.

FIG. 5 is a top view of an embodiment of the disclosure.

### DESCRIPTION OF THE PREFERRED EMBODIMENT

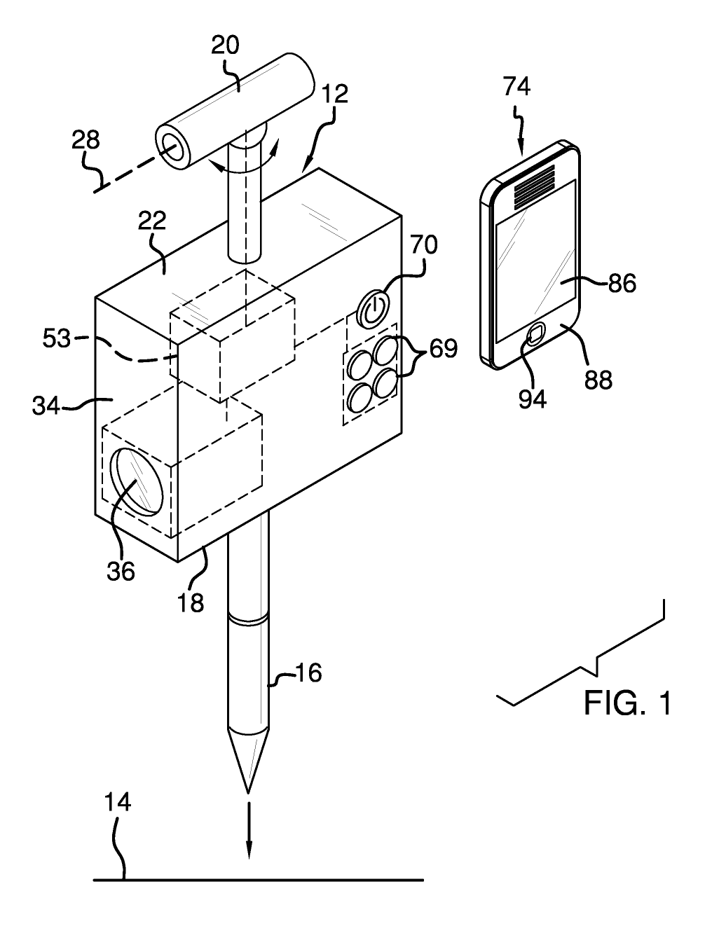

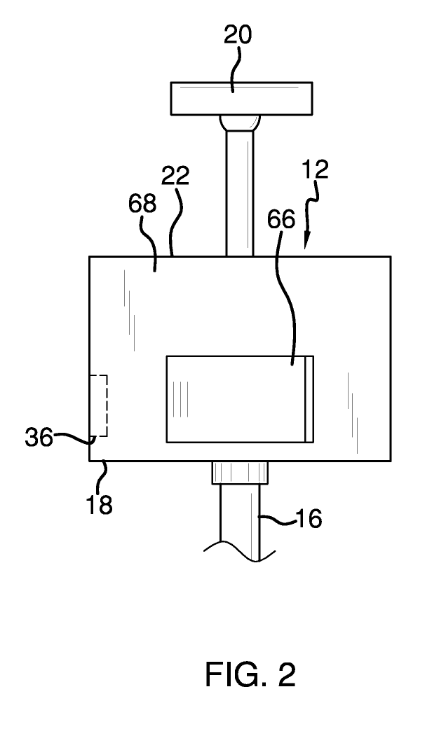

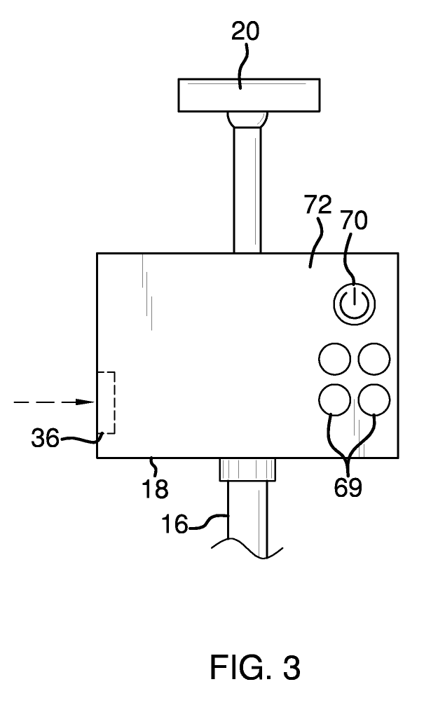

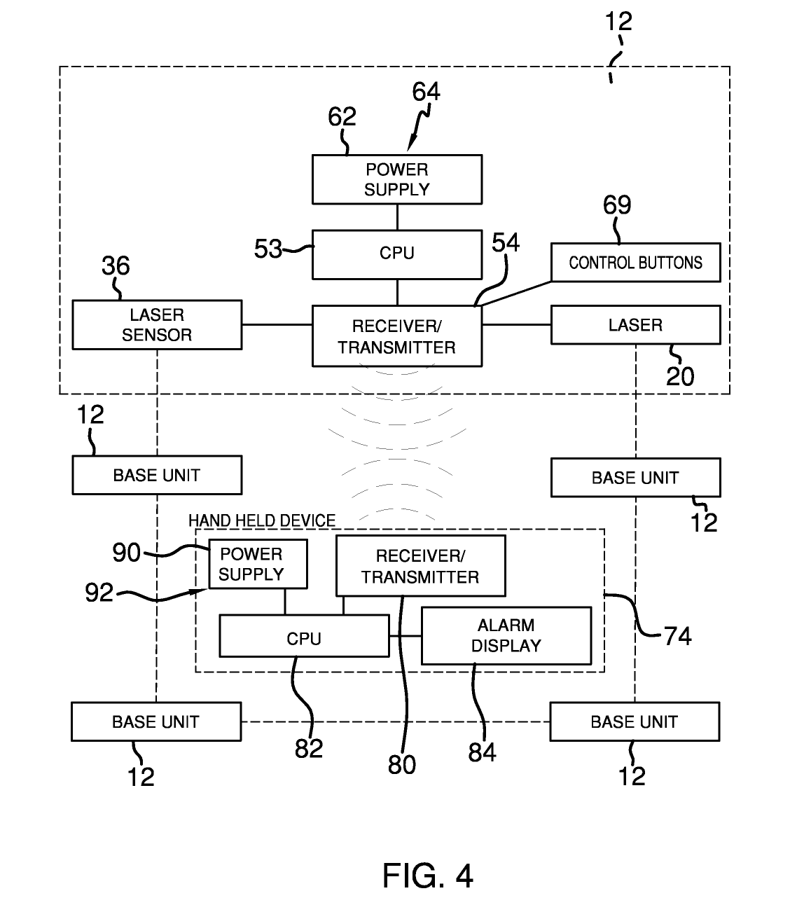

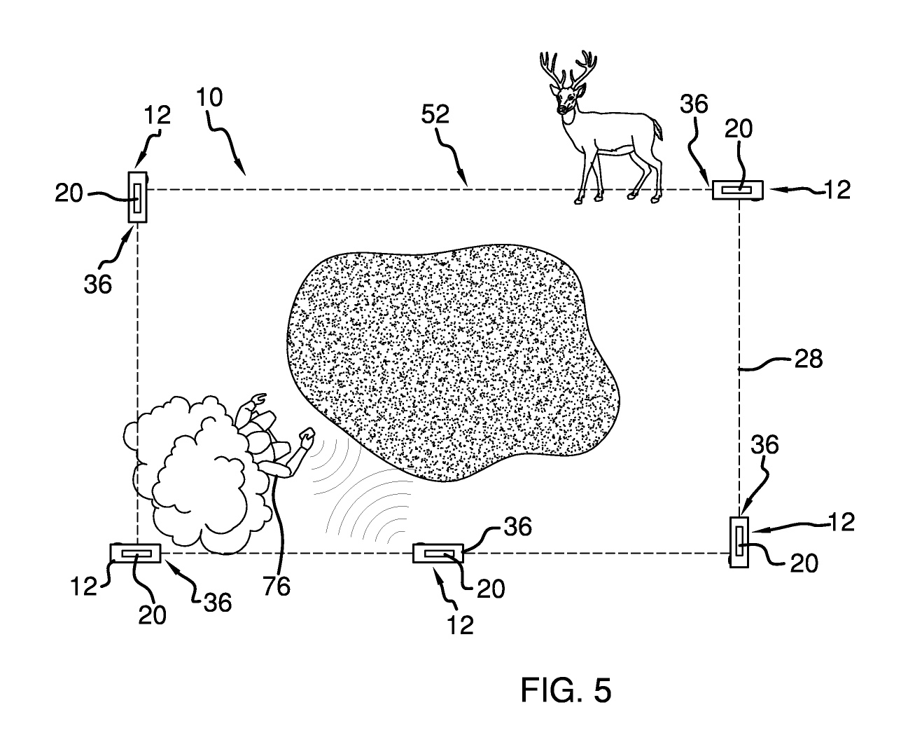

With reference now to the drawings, and in particular to FIGS. 1 through 5 thereof, a new alarm device embodying the principles and concepts of an embodiment of the disclosure and generally designated by the reference numeral 10 will be described.

As best illustrated in FIGS. 1 through 5, the configurable portable laser alarm system 10 generally comprises a plurality of base units 12. Each base unit 12 is positionable on a respective support surface 14 or multiple support surfaces such that the base units 12 are positioned in spaced relationship around an area defined by a user of the system 10. The base unit 12 may have a length between 10 cm and 15 cm, and a width between 5 cm and 8 cm. A stake 16 is coupled to and extends downwardly from a bottom side 18 of the base unit 12. The stake 16 is insertable into the support surface 14 so the base unit 12 is supported above the support surface 14. Additionally, the stake 16 has a telescopically adjustable length so the base unit 12 may be positioned a selected distance above the support surface 14.

Each of a plurality of lasers 20 is coupled to an associated one of the base units 12 such that the laser 20 emits a laser beam 28 outwardly from the associated base unit 12. Each laser 20 may be coupled to and extend from a top side 22 of the associated base unit 12. Each of a plurality of detectors 36 is coupled to an associated one of the base units 12. Each detector 36 is positionable to detect the laser beam 28 emitted from another of the base units 12. Each laser 20 is positionable relative to the associated base unit 12 wherein the laser 20 is adjustable to align the laser beam 28 emitted from the laser 20 towards the detector 36 of another of the base units 12. Adjustment of each laser 20 may be accomplished by conventional methods such as a ball joint or the like allowing the laser beam 28 to be pointed in a desired direction relative to the associated base unit 12. Each laser 20 may comprise a visible red laser with an operational frequency between 400 THz and 480 THz and a maximum power output of 5 mW. In addition, each laser 20 may have a maximum effective range of 200 m. Each detector 36 may be a laser detector of any conventional design with an operationally frequency between 400 THz and 480 THz.

Each of a plurality of base processors 53 is coupled to an associated one of the base units 12. Each base processor 53 is operationally coupled to the detector 36 coupled to the associated base unit 12 such that the base processor 53 selectively actuates the detector 36 coupled to the associated base unit 12. Each base processor 53 is electrically coupled to the detector 36 coupled to the associated base unit 12 and the laser 20 coupled to the associated base unit 12 wherein the base processor 53 selectively actuates the detector 36 coupled to the associated base unit 12 and the laser 20 coupled to the associated base unit 12. Each of a plurality of base transceivers 56 is coupled to an associated one of the base units 12. Each base transceiver 56 is operationally coupled to the base processor 53 coupled to the associated base unit 12 wherein the base transceiver 56 selectively transmits an alarm signal when the detector 36 coupled to the associated base unit 12 ceases to detect the laser beam 28 emitted from another base unit 28. Each base transceiver 56 may be an RF transceiver of any conventional design. Each base transceiver 56 is electrically coupled to the base processor 53 coupled to the associated base unit 12 wherein the base processor 53 coupled to the associated base unit 12 selectively actuates the base transceiver 56.

Each of a plurality of base actuators 70 is coupled to an associated one of the base units 12. Each base actuator 70 is operationally coupled to the base processor 53 coupled to the associated base unit 12 such that the base actuator 70 actuates the base processor 53 coupled to the associated base unit 12. Each base actuator 70 may be positioned on a front wall 72 of the associated base unit 12. A plurality of secondary actuators 69 is coupled to the front side 72 of the base unit 12. The plurality of secondary actuators 69 is electrically coupled to the base processor. Each of the plurality of secondary actuators 69 is actuatable to select one of a plurality of selectable performance parameters such as volume of alarm, type of alarm, detector sensitivity or other similar performance parameters.

Each of a plurality of base power supplies 62 is coupled to an associated one of the base units 12. Each base power supply 62 is electrically coupled to the base processor 53 coupled to the associated base unit 12 wherein the base power supply 62 selectively actuates the base processor 53 coupled to the associated base unit 12. Each base power supply 62 comprises at least one battery 64. Each base actuator 70 is electrically coupled to a respective base power supply 62 coupled to the associated base unit 12 wherein the base actuator 70 coupled to the associated base unit 12 selectively actuates the base power supply 62 as needed. The battery 64 is positioned beneath a battery cover 66 on a rear side 68 of each base unit 12.

A remote unit 74 is configured to be carried by a user 76. A remote transceiver 80 is coupled to the remote unit 74. The remove transceiver 80 may be an RF transceiver of any conventional design. The remote transceiver 80 receives the alarm signal from each base transceiver 56. A remote processor 82 is coupled to the remote unit 74. The remote processor 82 is operationally coupled to the remote transceiver 80. Each remote processor 82 is electrically coupled to the remote transceiver 80 wherein the remote processor 82 selectively actuates the remote transceiver 80. A remote actuator 94 is coupled to the remote unit 74. The remote actuator 94 is operationally coupled to the remote processor 82 wherein the remote actuator 94 actuates the remote processor 82. The remote actuator 94 may be positioned on a front wall 88 of the remote unit 74.

An alarm 84 coupled to the remote unit 74. The alarm 84 is operationally coupled to the remote processor 82 wherein the alarm 84 selectively generates an alarm sequence when the remote transceiver 80 receives the alarm signal from at least one of the base transceivers 56. The alarm 84 is electrically coupled to the remote processor 82 wherein the remote processor 82 selectively actuates the alarm 84. The alarm 84 may comprise a display 86 coupled to a front wall 88 of the remote unit 74. The display 86 displays indicia relating to the alarm 84 wherein the alarm 84 is configured for alerting the user 76 to an intrusion through a perimeter 52 defined by positioning of the base units 12.

A remote power supply 90 is coupled to the remote unit 74. The remote power supply 90 is electrically coupled to the remote processor 82 wherein the remote power supply 90 selectively actuates the remote processor 82. The remote power supply 90 comprises at least one battery 92 and may have an operational voltage between 6 VDC and 9 VDC. The remote actuator 94 is electrically coupled to the remote power supply 90 wherein the remote actuator 94 selectively actuates the remote power supply 90.

Each of a plurality of stakes 16 is coupled to and extends downwardly from a bottom 18 of an associated one of the base units 12 wherein each stake 16 is insertable into the support surface 14 wherein the associated base unit 12 is supported above the support surface 14.

In use, the base units 12 are arranged and positioned to define the perimeter 52 as desired. Each laser 20 is positioned to direct the laser beam 28 to the detector 36 of another one of the base units 12 such that the laser beams 28 surround the perimeter 52. Each base actuator 70 is manipulated to activate the system 10. When any one laser beam 28 is broken, as indicated by the associated detector 36 ceasing to receive the laser beam 28, the alarm 84 is activated to provide a warning of a breach of the perimeter 52. Although shown in a rectangular configuration, perimeter 52 may be shaped as desired by the user 76 by establishing multiple point to point laser 20 to detector 36 connections. The system 10 may also be configured to permit point to point establishment of base units 12 in series without having to form a complete circuit.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A laser alarm system for detecting intrusion into a user defined area, said system comprising:
a plurality of base units, each base unit being positionable on a respective support surface;
a remote unit;
a plurality of lasers, each said laser being coupled to an associated one of said base units such that said laser emits a laser beam outwardly from said associated base unit;
a plurality of detectors, each said detector being coupled to an associated one of said base units, each said detector being positionable to detect the laser beam emitted from another of said base units;
a plurality of base processors, each said base processor being coupled to an associated one of said base units, said base processor being operationally coupled to said detector coupled to said associated base unit such that said base processor selectively actuates said detector coupled to said associated base unit;
a plurality of base transceivers, each said base transceiver being coupled to an associated one of said base units, each said base transceiver being operationally coupled to said base processor coupled to said associated base unit wherein said base transceiver selectively transmits an alarm signal when said detector coupled to said associated base unit ceases to detect the laser beam emitted from another said base unit;
a plurality of base actuators, each said base actuator being coupled to an associated one of said base units, each said base actuator being operationally coupled to said base processor coupled to said associated base unit such that said base actuator actuates said base processor coupled to said associated base unit;
a remote transceiver coupled to said remote unit, said remote transceiver receiving said alarm signal from each said base transceiver;
a remote processor coupled to said remote unit, said remote processor being operationally coupled to said remote transceiver;
an alarm coupled to said remote unit, said alarm being operationally coupled to said remote processor wherein said alarm selectively generates an alarm when said remote transceiver receives said alarm signal from at least one of said base transceivers; and
a remote actuator coupled to said remote unit, said remote actuator being operationally coupled to said remote processor wherein said remote actuator actuates said remote processor.

2. The system of claim 1, further comprising a plurality of stakes, each said stake being coupled to and extending downwardly from a bottom of an associated one of said base units wherein each said stake is insertable into the support surface wherein said associated base unit is supported above the support surface.

3. The system of claim 1, further comprising each said base processor being electrically coupled to said detector coupled to said associated base unit and said laser coupled to said associated base unit wherein said base processor selectively actuates said detector coupled to said associated base unit and said laser coupled to said associated base unit.

4. The system of claim 1, further comprising each said base transceiver being electrically coupled to said base processor coupled to said associated base unit wherein said base processor coupled to said associated base unit selectively actuates said base transceiver.

5. The system of claim 1, further comprising:
a plurality of base power supplies, each said base power supply being coupled to an associated one of said base units;
each said base power supply being electrically coupled to said base processor coupled to said associated base unit wherein said base power supply selectively actuates said base processor coupled to said associated base unit; and
each said base power supply comprising at least one battery.

6. The system of claim 1, further comprising:
each said base actuator being positioned on a front wall of said associated base unit; and
each said base actuator being electrically coupled to a base power supply coupled to said associated base unit wherein said base actuator coupled to said associated base unit selectively actuates said base power supply.

7. The assembly of claim 1, further comprising each said remote processor being electrically coupled to said remote transceiver coupled to said associated base unit wherein said remote processor selectively actuates said remote transceiver coupled to said associated base unit.

8. The system of claim 1, further comprising said alarm being electrically coupled to said remote processor wherein said remote processor selectively actuates said alarm.

9. The system of claim 8, further comprising:
said alarm comprising a display coupled to a front wall of said remote unit;
said display displaying indicia relating to said alarm wherein said alarm is configured for alerting a user to an intrusion through a perimeter defined by positioning of said base units.

10. The system of claim 1, further comprising:
a remote power supply coupled to said remote unit;
said remote power supply being electrically coupled to said remote processor wherein said remote power supply selectively actuates said remote processor; and
said remote power supply comprising at least one battery.

11. The system of claim 1, further comprising:
said remote actuator being positioned on a front wall of said remote unit; and
said remote actuator being electrically coupled to a remote power supply wherein said remote actuator selectively actuates said remote power supply.

12. The system of claim 1, further comprising each said laser being coupled to and extending from a top side of said associated base unit.

13. The system of claim 12, further comprising each said laser being positionable relative to said associated base unit wherein said laser is adjustable to align the laser beam emitted from said laser towards said detector of another of said base units.

14. A laser alarm system for detecting intrusion into an area, said assembly comprising:
a plurality of base units, each base unit being positionable on a respective support surface;
a remote unit carried by a user;
a plurality of lasers, each said laser being coupled to an associated one of said base units such that said laser emits a laser beam outwardly from said associated base unit;
a plurality of detectors, each said detector being coupled to an associated one of said base units, each said detector being positionable to detect the laser beam emitted from another of said base units;
a plurality of base processors, each said base processor being coupled to an associated one of said base units, said base processor being operationally coupled to said detector coupled to said associated base unit such that said base processor selectively actuates said detector coupled to said associated base unit, each said base processor being electrically coupled to said detector coupled to said associated base unit and said laser coupled to said associated base unit wherein said base processor selectively actuates said detector coupled to said associated base unit and said laser coupled to said associated base unit, each said base actuator being positioned on a front wall of said associated base unit;
a plurality of base transceivers, each said base transceiver being coupled to an associated one of said base units, each said base transceiver being operationally coupled to said base processor coupled to said associated base unit wherein said base transceiver selectively transmits an alarm signal when said detector coupled to said associated base unit ceases to detect the laser beam emitted from another said base unit, each said base transceiver being electrically coupled to said base processor coupled to said associated base unit wherein said base processor coupled to said associated base unit selectively actuates said base transceiver;
a plurality of base actuators, each said base actuator being coupled to an associated one of said base units, each said base actuator being operationally coupled to said base processor coupled to said associated base unit such that said base actuator actuates said base processor coupled to said associated base unit;
a plurality of base power supplies, each said base power supply being coupled to an associated one of said base units, each said base power supply being electrically coupled to said base processor coupled to said associated base unit wherein said base power supply selectively actuates said base processor coupled to said associated base unit, each said base power supply comprising at least one battery, each said base actuator being electrically coupled to a respective base power supply coupled to said associated base unit wherein said base actuator coupled to said associated base unit selectively actuates said base power supply;
a remote transceiver coupled to said remote unit, said remote transceiver receiving said alarm signal from each said base transceiver;
a remote processor coupled to said remote unit, said remote processor being operationally coupled to said remote transceiver, each said remote processor being electrically coupled to said remote transceiver coupled to said associated base unit wherein said remote processor selectively actuates said remote transceiver coupled to said associated base unit;
a remote actuator coupled to said remote unit, said remote actuator being operationally coupled to said remote processor wherein said remote actuator actuates said remote processor, said remote actuator being positioned on a front wall of said remote unit;
an alarm coupled to said remote unit, said alarm being operationally coupled to said remote processor wherein said alarm selectively generates an alarm when said remote transceiver receives said alarm signal from at least one of said base transceivers, said alarm being electrically coupled to said remote processor wherein said remote processor selectively actuates said alarm, said alarm comprising a display coupled to a front wall of said remote unit, said display displaying indicia relating to said alarm wherein said alarm is configured for alerting a user to an intrusion through a perimeter defined by positioning of said base units;
a remote power supply coupled to said remote unit, said remote power supply being electrically coupled to said remote processor wherein said remote power supply selectively actuates said remote processor, said remote power supply comprising at least one battery, said remote actuator being electrically coupled to a remote power supply wherein said remote actuator selectively actuates said remote power supply; and
a plurality of stakes, each said stake being coupled to and extending downwardly from a bottom of an associated one of said base units wherein each said stake is insertable into the support surface wherein said associated base unit is supported above the support surface.
